(19) United States
(12) Patent Application Publication
(10) Pub. No.: US 2013/0196697 A1
(43) Pub. Date: Aug. 1, 2013

(54) MOBILE MESSAGING HUB ENABLING ENTERPRISE OFFICE TELEPHONE NUMBERS

(71) Applicant: MediaFriends, Inc., Cambridge, MA (US)

(72) Inventors: Eugene Lee Lew, Olney, MD (US); Vasileios J. Gianoukos, Winchester, MA (US)

(73) Assignee: MEDIAFRIENDS, INC., Cambridge, MA (US)

(21) Appl. No.: 13/803,331

(22) Filed: Mar. 14, 2013

Related U.S. Application Data
(63) Continuation-in-part of application No. 13/441,105, filed on Apr. 6, 2012.
Application No. 13/441,105 is a continuation-in-part of application No. 13/111,109, filed on May 19, 2011.
Application No. 13/111,109 is a continuation-in-part of application No. 12/535,323, filed on Aug. 4, 2009.
(60) Provisional application No. 61/137,918, filed on Aug. 5, 2008.
(60) Provisional application No. 61/164,705, filed on Mar. 30, 2009.

(51) Int. Cl. H04W 4/14

(52) U.S. Cl. CPC H04W 4/14
USPC 455/466

(57) ABSTRACT

A messaging hub provides communication services for user devices associated with an enterprise office telephone number. The messaging hub establishes a secure connection between the messaging hub local SMSC/MMSC and a data adapter of a unified communications service, provision the enterprise office telephone number for use in a global SMS/MMS network and delivers messages addressed to the enterprise office telephone number to selected user devices.

### CROSS REFERENCE TO RELATED APPLICATIONS

This application is a continuation in part of U.S. patent application having Ser. No. 13/441,105 entitled “MESSAGING HUB SYSTEM,” filed Apr. 6, 2012 that shares inventorship with the present application and which is a continuation in part of U.S. patent application having Ser. No. 13/111,109 entitled “SOCIAL MESSAGING HUB,” filed May 19, 2011 that shares inventorship with the present application and which is a continuation in part of U.S. patent application having Ser. No. 12/535,323 entitled “SMS TECHNOLOGY FOR COMPUTERIZED DEVICES,” filed Aug. 4, 2009 that shares inventorship with the present application and which claims the benefit of U.S. provisional patent application Ser. Nos.: 61/137,918, entitled “Apparatus and methods for TV applications,” filed Aug. 5, 2008; 61/164,705, entitled “SMS Technology for Computerized Devices,” filed Mar. 30, 2009; and 61/346,133 entitled “MESSAGING SYSTEM AND DEVICES,” filed May 19, 2010; that share inventorship with the present application. The entire teachings and contents of these Patent Applications are hereby incorporated by reference herein in their entireties.

### FIELD OF THE INVENTION

The present invention relates to messaging and communications, and to mobile telephony, text messaging, instant messaging, multimedia messaging, enterprise office systems, unified communications service, personal computers and data enabled digital devices.

### BACKGROUND

People around the world are confronted by a number of communications and writing devices which have evolved relatively recently from the separate areas of telephone communications networks, wireless networks, television or cable networks, and computer networks and personal computers. The more recent devices—mobile phones with message/picture/video texting, personal digital devices for Internet browsing and computer-based blogging and networking sites—have been shaped in part by the separate networks of origin, but the nature and capabilities of many of these now-ubiquitous devices have both converged, and also advanced quickly in different directions as the industries controlling each sector have capitalized on their market power, reservoir of legacy subscribers and, in some cases, regulatory barriers and proprietary network equipment and connection protocols, to introduce new consumer features, often employing developments from other consumer products, and aiming to lure subscribers by mimicking those products. However, in doing so, each industry has also been limited by its own equipment, data transfer speeds and connection abilities.

Thus, as digital imaging advanced and consumers learned to take and handle images and to attach the images to e-mail messages, imaging chipsets were incorporated into mobile telephones and the mobile phones were configured to display images and allow their transmission between phones. Text and message protocols allowed transmission of ‘instant’ messages, and coded standardized greetings and messages between phone users, filling a niche for immediate portable, personal communication that was not met by existing personal computer devices. Devices like the iPhone®, introduced in 2007 allowed a user to access his Internet-based email from his mobile phone via a specially-configured data connection with his mobile service provider, and to exchange content via wireless connection to his personal computer.

However, despite these developments blurring boundaries between the classical phone, mobile telephone, Internet, wireless and television or cable networks, there has not been a convergence. Rather, although industry and government groups have promoted interface standards for several different classes of data or communication, each industry has retained much of its special structure, and the devices served by an industry (such as mobile telephones) may find their feature set constrained by intrinsic limitations of bandwidth and connectivity, by available networking equipment base, and by the level of contractual cooperation agreements of its provider. The many different classes of communications systems now available, and the many separate provider networks in each class, have also required the development of new supporting entities, such as nationally- or internationally-extending registries, aggregators, exchanges and other entities, in order to affect timely transfer of data, messages and/or entertainment content. This second-level infrastructure imposes further constraints of the feasible, or economically feasible, set of features that a consumer may exercise. Thus, for example, mobile telephones have been augmented with a display and the ability to run small applications such as games, MP3 players, Internet browsers/applications and email retrieval, while personal computers have the capability to run larger programs, employ wireless connectivity and perform voice-over-IP (VOIP) Internet communications. Various special-purpose applications requiring cross-platform connections may be provided, or applications simulating cross-platform capabilities may be developed, by a service provider, such as a television-displayed chat session available for subscribers of a TV provider. However, many other personal devices while having large data capacity, ability to connect to another user device and ability to run entertainment apps, may entirely lack the mobile telephone electronic circuitry necessary for exchanging mobile messages with telephone users. Additionally, the delivery of messages in some messaging systems is affected by limitations of carrier networks and international boundaries. It is therefore desirable to provide a system for enhanced communication between personal devices.

Although, email, IM and web surfing can be monitored and audited at an Enterprise level, the ability to monitor, audit, or filter an Enterprise's personnel's electronic communications in addition to securing corporate assets by such communications has not been possible with regard to SMS/MMS previously due to the nature of traditional SMS/MMS. Traditional SMS/MMS is based on Signaling System No. 7, analog telephone signaling protocols (SS7) switching technology and on a physically separate network to which an Enterprise has no visibility or access.

While personnel at an Enterprise may be using mobile phones or tablets that are provided and paid for by the Enterprise, currently, there is no method by which to determine what the SMS/MMS communications is being used for (e.g., company business, personal business, or a leak of confidential and proprietary information) unlike other electronic communications methods (digital: email, IM, etc.) which are easily tracked/monitored. This is an issue, especially for trade secrets, financial data of publicly traded companies, and Merger & Acquisition activity information.

Enterprises have never had ability to monitor or audit a service that they do not manage such as the PSTN beyond rudimentary time based usage statistics. Carriers cannot retain the message content of SMS messages due to the sheer volume of the enormous amount of data based on the quantity of SMS messages that flow through its network. Enterprises have in some cases made it corporate policy that SMS/MMS usage is

NOT allowed (e.g., some Wall St financial institutions have done this) in an attempt to prevent leakage of sensitive data via SMS/MMS. One barrier to solving this problem has always been the physical separation of the networks involved (PSTN vs. Internet) and technology (SS7 vs. IP). The problem cannot be solved if the Enterprise cannot obtain physical access to the network where the problem is occurring. In theory, carriers could technically solve the issue, but the carriers would be prevented by privacy laws and even if granted relief from privacy laws, the task due to the sheer volume of data would make it cost prohibitive to be justified.

SMS is a carrier service that an Enterprise has zero control over. Additionally, carriers do not monitor or retain SMS message content (except for very short, finite periods). Thus an Enterprise, even if suspicious of possible leaks of its proprietary data (trade secrets, financial, M&A), it has no recourse to determine the source of these leaks as the carriers do not have the data retention policies or the ability to search historical SMS.

A unified communication (UC) service is the integration of real-time communication services such as instant messaging (chat), presence information, telephony (including IP telephony), video conferencing, data sharing, call control and speech recognition with non-real-time communication services such as unified messaging (integrated voicemail, e-mail, SMS and fax). UC is not necessarily a single product, but a set of products that provides a consistent unified user interface and user experience across multiple devices and media types. There have been attempts at creating a single product solution however the most popular solution is dependent on multiple products. In its broadest sense UC can encompass all forms of communications that are exchanged via the medium of the TCP/IP network to include other forms of communications such as Internet Protocol Television (IPTV) and Digital Signage Communications as they become an integrated part of the network communications deployment and may be directed as one to one communications or broadcast communications from one to many.

UC service allows an individual to send a message on one medium and receive the same communication on another medium. For example, one can receive a voicemail message and choose to access it through e-mail or a cell phone. If the sender is online according to the presence information and currently accepts calls, the response can be sent immediately through text chat or video call. Otherwise, it may be sent as a non-real-time message that can be accessed through a variety of media.

Landline phones (also referred to as classical phones, fixed line phone) and associated phone numbers are not capable of mobile messaging functions. They are only used for voice functions, and by their nature, are not “mobile.” Thus, in order to provide a mobile contact point, users must secure a separate mobile phone number associated with a mobile device to receive services such as text messaging and other capabilities. In a business setting, employees generally are assigned a business phone number and these business numbers are managed by a private branch exchange PBX or computerized branch exchange (CBX).

### SUMMARY OF THE INVENTION

Enterprise landline phones are not generally capable of mobile messaging functions. Associated enterprise phone numbers are not used for indicating the source or destination of SMS messages. Currently, enterprises have no ability to monitor or audit SMS communications of its personnel or to apply spam filters to SMS message. Configurations disclosed herein substantially overcome the shortcomings of conventional messaging and enterprise communications systems. In particular a technique for enabling an enterprise office telephone number to be used for SMS/MMS/EMS message communication includes establishing a secure connection between the messaging hub local SMSC and a data adapter of a unified communications service, identifying the enterprise office telephone number, provisioning the enterprise office telephone number. The provisioning includes registering the enterprise office telephone number with a messaging hub having access to a local SMSC/MMSC, gaining access to a mobile message network using the enterprise office telephone number and registering the enterprise office telephone number in a database accessible by an SMSC/MMSC with access to a global SMS/MMS network. Such a technique enable the use of enterprise phone number as the source or destination of SMS/MMS messages.

A further embodiment includes assigning an identification data element (e.g., SPID/ESPID/VSPID/AltSPID/SIP URI) to be used in conjunction with the enterprise office telephone number and homing the assigned identification data element within the messaging hub for message traffic delivery. Another embodiment includes receiving a message corresponding to the assigned identification data element, determining whether a session exists over the secure connection to the data adapter, queuing a message for later delivery in response to determining that no session exists and redirecting the message to the session in response to determining that the session exists.

A further embodiment includes auditing the received message. Such a technique enables an enterprise to audit business SMS messages in order to protect an enterprise's intellectual property and financial data. A further embodiment includes determining whether the received message is spam and deleting the received message in response to determining that the received message is spam. A further embodiment includes associating a plurality of user devices with the enterprise office telephone number and determining which ones of the plurality of user devices receive the received message. A further embodiment includes determining a location of one of the user devices, communicating the location of one of the plurality of user devices to the unified communications service and delivering a location specific message to the one of the plurality of user devices.

A further embodiment includes sending an SMS/MMS message by associating a DID number of the enterprise office telephone number with the message. A further embodiment includes auditing the message to be sent.

Identifying the enterprise office telephone number further comprises identifying a block of enterprise office telephone numbers.

A further embodiment includes providing a messaging application running on the messaging hub and within the unified communications service. A further embodiment includes providing a push service to transfer a message from the messaging hub to the unified communications service via the messaging application. A further embodiment includes providing a pull service to transfer a message from the messaging hub to the unified communications service via the messaging application. A further embodiment includes provisioning into a third party directory, a carrier's directory, a government directory or a government master directory.

A messaging hub for enterprise Short Message Service/Multimedia Messaging Service/Enhanced Messaging Service (SMS/MMS/EMS) communications includes an interface to a local SMSC/MMSC, at least one application server coupled to the local SMSC/MMSC through the interface. The local SMSC/MMSC is an interfaced to at least one external SMSC/MMSC in an external SMS/MMS/EMS network. The hub further includes a database coupled to at least one database server coupled to the application server providing contact management data, application management data and message management data, an interface between the messaging hub and a data adapter of a unified communications service, an application interface to a unified communications service, a message retention queue for delaying delivery of SMS/MMS messages and an interface to a push service.

In further embodiments the messaging hub includes an interface to a pull service, an auditing engine including a spam filter, a user device delivery selector and a location services engine.

A computer readable storage medium for tangibly storing thereon computer readable instructions for a messaging application having an on premise component and a messaging hub component, the messaging hub component having for a method includes instructions for establishing a secure connection between the messaging hub local SMSC and a data adapter of a unified communications service, identifying the enterprise office telephone number, provisioning the enterprise office telephone number, the provisioning comprising, registering the enterprise office telephone number with a messaging hub having access to a local SMSC/MMSC, gaining access to the mobile message network using the non-mobile enterprise office telephone number and registering the enterprise office telephone number in a database accessible by an SMSC/MMSC with access to the global SMS/MMS network. An on premise component includes instructions for transferring an enterprise office telephone number over the secure connection and sending and receiving SMS/MMS messages over the secure connection. Such techniques assist protection/detection of Enterprise's intellectual property and financial data.

It is to be understood that the features of the messaging hub can be embodied strictly as a software program, as software and hardware, or as hardware alone such as within a single processor or multiple processors, or within an operating system or within a software application.

Other arrangements of embodiments disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing test systems explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other media such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. Embodiments of the system can be distributed between many software processes on several data communications devices, or all processes could run on a small set of dedicated computers or on one computer alone.

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention. These and other features of the invention will be understood from the description and claims herein, taken together with the drawings of illustrative embodiments, wherein

FIG. 1 is a schematic illustration of a messaging hub, a unified communications service and network environment/messaging infrastructure in accordance with one example embodiment disclosed herein;

FIG. 2 is a more detailed schematic illustration of the messaging hub and messaging infrastructure of FIG. 1;

FIG. 3 is a schematic illustration of the messaging hub of FIG. 1;

FIG. 4 illustrates further details an embodiment of the messaging hub of FIG. 1 including an application providing communication with a data adapter of a unified communications service;

FIG. 5 illustrates details of an embodiment of the messaging hub of FIG. 1 including details of the provisioning process; and

FIGS. 6-8 are flow charts of processing steps performed for provisioning enterprise office telephone numbers and operation of the messaging hub of FIG. 1.

### DETAILED DESCRIPTION

A messaging hub, as disclosed herein, enables users to have “one telephone number” for their business communications including voice and mobile messaging, versus having two separate telephone numbers (one for office and one for mobile). The messaging hub and related applications and interfaces are referred to herein as messaging hub or messaging hub system.

In certain embodiments the messaging hub enables the monitoring, auditing and filtering of SMS/MMS communications by Enterprise personnel without changing the basic function of SMS/MMS by operating SMS/MMS over IP technology and implementing tools for inspection purposes on the messaging hub to enable Enterprises to collect or alert when certain triggers are activated. The method of operating SMS/MMS over IP and implementing specifically for Enterprises (e.g.—utilize landline phone number assigned to Enterprise personnel or give out new ‘virtual phone numbers’) facilitates such an environment.

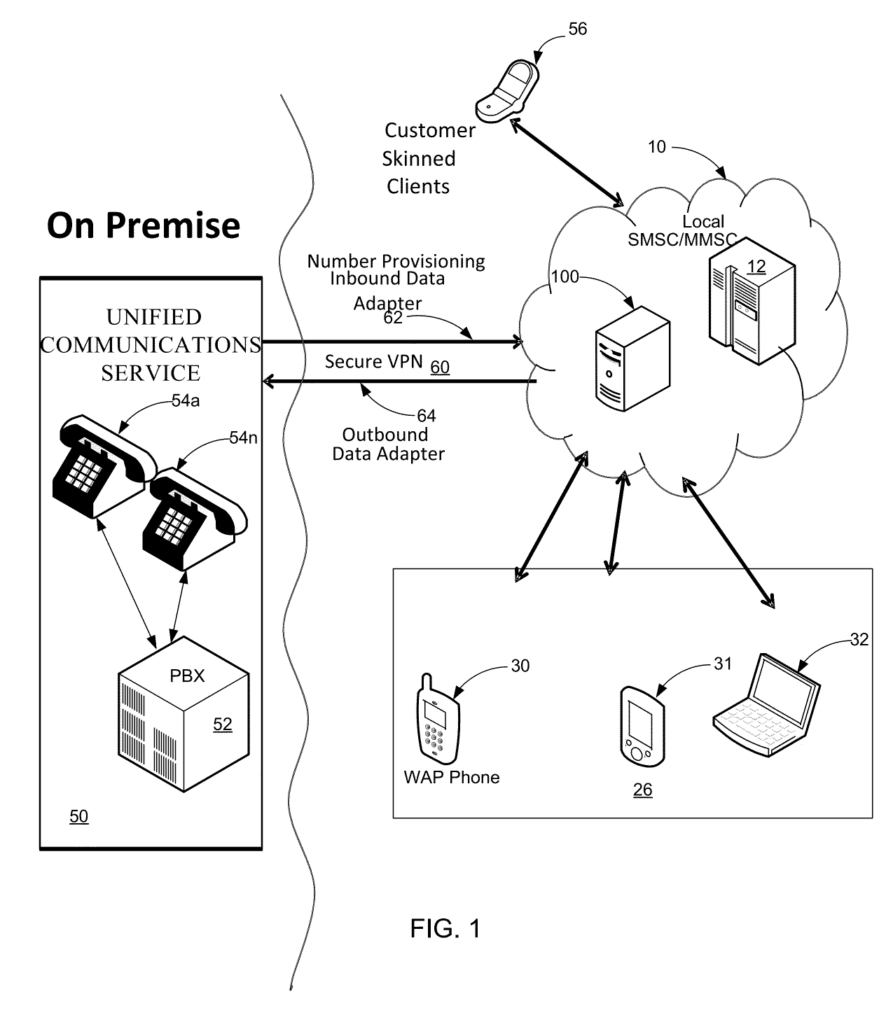

Now referring to FIG. 1, an exemplary messaging hub 100 operates in network environment 10 and can communicate with and relay messages to user devices, for example, a data enabled mobile phone 30, a data enabled WiFi phone 31 and other data enabled devices (not shown) such as a laptop, netbook, tablet and a smart phone. The messaging hub 100 communicates with a unified communication service (UCS) 50, in one embodiment, over a secure connection 60 (e.g. VPN connection). The unified communication service 50 generally includes a PBX 52 or alternatively a CBX (not shown) and communicates data and number provisioning information over an inbound data adapter 62 and outbound data adapter 64 operating within the secure VPN connection 60. In addition to phone numbers, data transferred between the unified communication service 50 and the messaging hub 100 includes but is not limited to:

SMS/MMS/EMS messages;

administrative information such as origin, destination and other custom and proprietary data associated with the messages, carrier or provider information;

SMS/MMS/EMS messages can also be sent and received directly between UCS 50 to and from data enabled devices 26 relayed through Local SMSC/MMSC 12 or global SMSC/MMSC 13 if the UCS 50 is equipped to accommodate SMS/MMS traffic.

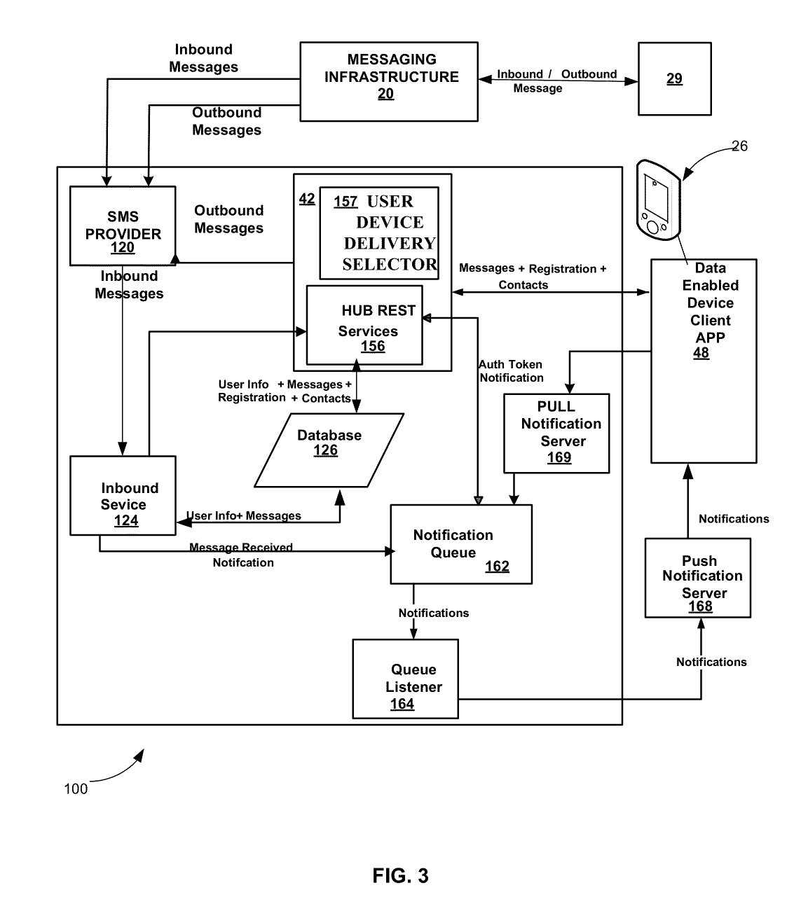

Customer (Enterprise) skinned clients is a cosmetic enhancement to the smart phone app (e.g., smart phone app 48 FIG. 3), but it provides a unique distinguishing separation of the native mobile SMS/MMS client (if present) from the Enterprise SMS/MMS client, which is associated to two different phone numbers. By having a cosmetically different SMS/MMS client, it allows physical separation of the messages associated with each phone number. In addition, it allows a cosmetic customization to show affinity to the specific Enterprise of the user.

In operation, the messaging hub 100 establishes a secure connection to a local short message service center/multimedia message service center SMSC/MMSC 12 and the data adapters 62 and 64 of unified communications service 50. The SMSC/MMSC is a network element in the network environment 10. Its purpose is to store, forward, convert and deliver SMS/MMS messages. A local SMSC/MMSC is one that is either owned or operated or is accessible by the local operating entity associated with the message hub 10.

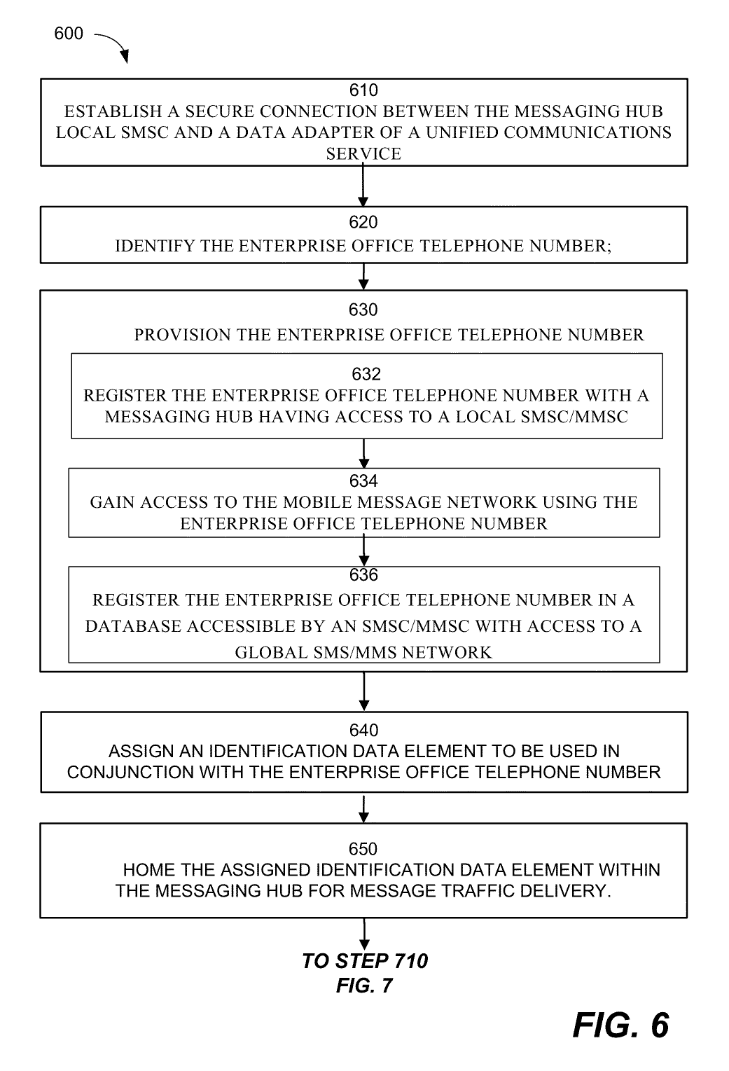

The messaging hub 100 identifies an enterprise office telephone number provided by the unified communications service 50. In one embodiment the messaging hub 100 identifies a block or pool of Enterprise office landline phone numbers (e.g.—617-555-0001 to 617-555-9999) to be mobile messaging enabled. The messaging hub 100 provisions the enterprise office telephone number and then messages can be directed to the enterprise office telephone number and received on one or more of the user's data enabled devices. The provisioning process is detailed below in conjunction with FIG. 6.

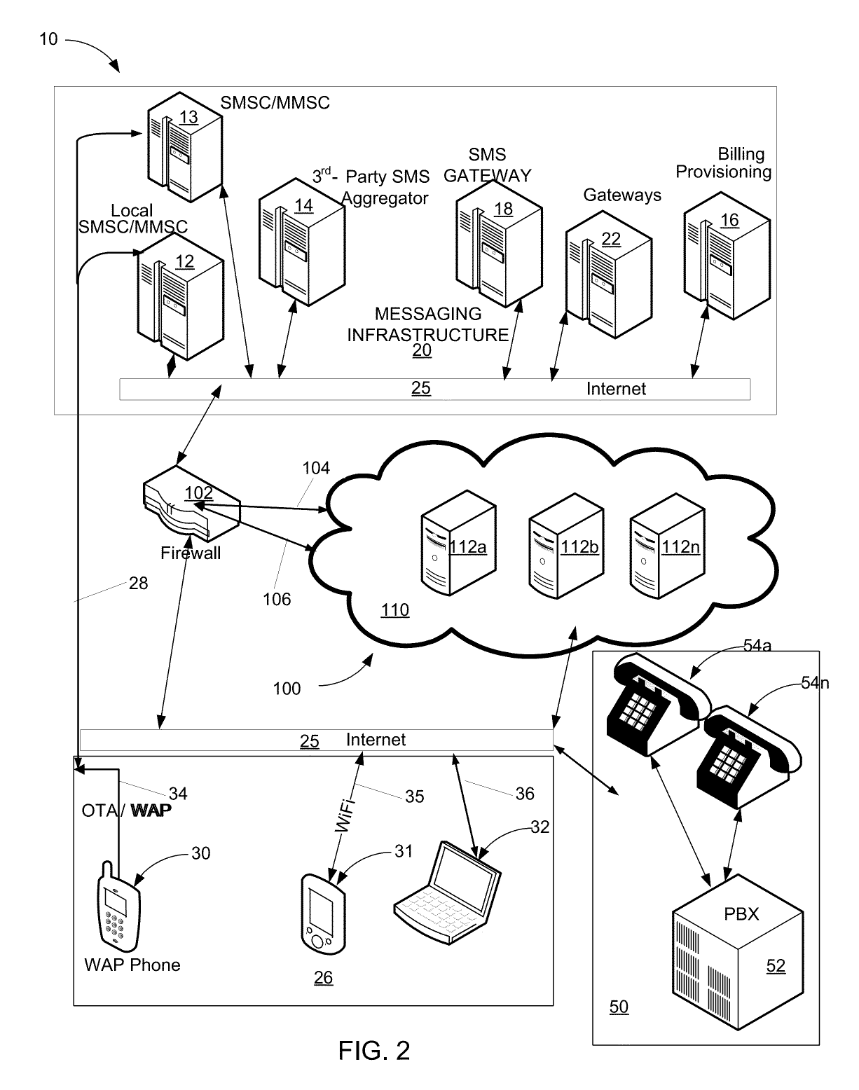

Now referring to FIG. 2, the exemplary messaging hub 100 operates in the network environment 10 which includes global messaging infrastructure 20. The messaging hub 100 includes one or more processors 112a-112n and is coupled to the network environment 10 and global messaging infrastructure 20 through a firewall 102. The firewall 102 is typically located at a messaging hub 100 hosting facility.

The global messaging infrastructure 20 includes, but is not limited to, a local Short Message Service Center/Multimedia Messaging Service Center (SMSC/MMSC) 12, a third party SMS/MMS aggregator 14 (also referred to a SMS/MMS aggregator 14), a billing and provisioning system 16, an SMS/MMS Gateway (SMS/MMS-GW) 18, messaging gateways 22 and a cellular phone infrastructure 28. Other components of the global messaging infrastructure 20 include an external (Global) SMSC/MMSC network 13 and additional SMS/MMS-Gateways and other SMSCs/MMSCs and billing and provisioning systems provided by additional mobile carrier service providers (not shown). The local SMSC/MMSC 12 and the billing and provisioning system 16 are typically operated by a mobile carrier service provider. The Global SMSC/MMSC network 13 is typically operated by multiple mobile carriers and third parties. The messaging gateways 22 include connections to IM services, for example AOL instant messenger (AIM), Yahoo Messenger, Windows Live Messenger, Jabber, Skype, Tencent QQ, ICQ and GoogleTalk (gTalk), and other networks such as Facebook and Twitter.

In one embodiment, the messaging hub 100 communicates with the systems in the global messaging infrastructure 20 (e.g., local SMSC/MMSC 12, the third party SMS/MMS aggregator 14 and the billing and provisioning system 16) using various network protocols including the Short Message Peer-to-Peer (SMPP) protocol, Hypertext Transfer Protocol (HTTP), Wireless Application Protocol (WAP), Signaling Transport (SIGTRAN) protocol or SS7 protocol. The SMPP protocol is a telecommunications industry protocol for exchanging SMS messages between SMS peer entities. The HTTP and WAP protocols are a telecommunications industry protocols for exchanging MMS messages between MMS peer entities.

In this embodiment, the link between the messaging hub 100 and the global messaging infrastructure 20 is secured by the firewall 102 using a virtual private network (VPN) connection with HTTPS using 128-bit or higher encryption, for example, 1024 bit (3DES-SHA1) encryption. Messages are transferred over SMPP link 104 and provisioning and single sign on (SSO), XML and SOAP messages and other control traffic are interchanged over control link 106. In another embodiment, messages are transferred over SIGTRAN (SS7 over IP) depending on the connection (e.g., a connection to a European Mobile Operator).

The messaging hub 100 is connected via the Internet 25 or a dedicated connection to the global messaging infrastructure 20 that relays messages between existing customer equipment, for example, a mobile phone 29, a data enabled mobile phone 30, a data enabled WiFi phone 31 and other data enabled devices (not shown) such as a laptop, netbook, tablet and a smart phone.

The mobile phone 29 can be connected to the messaging hub 100 over the cellular phone infrastructure 28 through the local SMSC/MMSC 12 using an SMS protocol. The messaging hub 100 is connected via the Internet 25 or a dedicated connection to the unified communications service 50 of one or more business enterprises. The Global SMSC/MMSC network 13 is also connected to the cellular phone infrastructure 28. The data enabled mobile phone 30 can be connected to the messaging hub 100 over the cellular phone infrastructure 28 using a data connection provided by OTA/WAP protocols. A data enabled WiFi phone 31 can be connected to the messaging hub 100 via a WiFi connection to the Internet. It is understood that a mobile phone can be data enabled via both a WAP connection and a WiFi connection. The data enabled WiFi phone 31 is sometimes referred to as a dual mode phone if it can also connect over WAP.

A laptop personal computer 32 can be connected to the messaging hub 100 via a wired Internet 25 connection 36 or a wireless Internet connection (not shown). Other mobile/portable data enabled devices (not shown) include but are not limited to a portable media players, personal digital assistants, Wi-Fi mobile platforms, pad-tablet computers, portable e-Readers, personal computers, portable game players, game consoles and netbook computers which can be connected to the messaging hub 100 via the Internet 25 using a WiFi, wired or other wireless connection. These devices, the data enabled mobile phone 30 and the data enabled WiFi phone 31 are collectively referred to as a data enabled device 26 or devices 26 and these devices generally establish an Internet protocol (IP) session or connection with the messaging hub 100. Some data enabled devices 26 interface with the messaging hub 100 using a client browser 37 and other data enabled devices 26 interface with the messaging hub 100 using a client software component (also referred to as a client application or simply “app”). The client browser 37 communication to a corresponding web application and the client application (app) are collectively referred to as application 40.

In operation and as described below in more detail, the messaging hub 100 obtains a plurality of unique identifiers which in one embodiment, are telephone numbers acquired through or serviced by a competitive local exchange carrier (CLEC), local exchange carrier (LEC) or other provider that is authorized to issue or service registered phone numbers, and the set of numbers so issued may be serviced by that carrier's network, another carrier network or by a separate entity or sub-entity such as a network unaffiliated virtual operator (NUVO), that serves as the service provider to users and functions as a destination carrier to receive messages directed to its telephone numbers from the SMS aggregator 14, an SMS operator (e.g., a mobile carrier), a content provider or another NUVO, and to provide an Internet interface for delivery of the messages to users' data enabled devices 26.

The messaging hub 100 assigns a user of a data enabled device 26 a unique identifier from the plurality of unique identifiers and the messaging hub 100 associates the unique identifier with a data enabled device identifier. The data enabled device identifier includes but is not limited to a network address, a Unique Device Identifier (UDID), a Media Access Control address (MAC address), a International Mobile Equipment Identity (IMEI), a Mobile Equipment Identifier (MEID), a Electronic Serial Number (ESN) and a CPU serial number, of the data enabled device 26. The messaging hub 100 registers the association between the unique identifier with a data enabled device identifier in a database. After the user is assigned a unique identifier, a userid and password is when the application 40 is started. When the user registers the enabled device 26 and signs-in to an IM service or media account (e.g., AIM, Yahoo

Messenger, Windows Live Messenger and GoogleTalk, Facebook, Twitter, etc.) the account information is stored, in certain embodiments, on the user's data enabled device in a mini database for app. Previously stored login/signon information can be retrieved in order to sign on the user automatically.

In one embodiment, the user is given a registered phone number and unique IP addressable identification. The IP addressable identification is a connectionless method by which the user supplied email address, supplied as part of the registration process for contact purposes, is combined with the unique registered phone number. By affecting such a combination of two unique identifiers, each supplied by separate parties, a unique identification is created that can be located in a connectionless manner on the Internet.

For inbound messages (i.e., sent to the data enabled device 26), the messaging hub 100 receives the text message from the global messaging infrastructure 20 (e.g., message service local SMSC/MMSC 12, or SMS aggregator 14). The message is directed to the user's data enabled device 26 having the registered unique identifier obtained from the text message source, and the messaging hub 100 provides the message to an inbound service, establishes a connection between a data enabled device 26 and the inbound service and pushes the text message from the inbound service to an application or web browser running on the data enabled device 26.

For outbound messages (i.e., sent from the data enabled device 26). the messaging hub 100 receives the text message from the data enabled device 26 including a destination identifier for the message, processing the message and provide the message to SMS destination through the global messaging infrastructure 20 (e.g., local SMSC/MMSC 12, or SMS aggregator 14) for delivery to the message recipient.

The messaging hub 100 can submit multiple messages in one transmission using a 1 to many feature in conjunction with the application 40 (i.e., web client or smart phone app). The messaging hub 100 transfers messages between data enabled devices 26 without the use of the global message infrastructure 20 even if phone numbers are used as the addresses. Provisioning and single sign on (SSO) are incorporated in the messaging hub 100 such that once a registered phone number and other user information is stored in database 126 connections and logins can be established automatically.

As described below in conjunction with FIGS. 2-5, the messaging hub 100 may be configured to interface and exchange messages with SMS/MMS-capable mobile phones and smart phones, and operates such that incoming mobile text messages are transparently routed, locally or internationally, through existing SMS/MMS delivery organizations in the messaging infrastructure.

More generally, embodiments of the messaging hub 100 include an application which enables a user (sometimes referred to herein as a subscriber) to perform SMS/MMS/EMS or chat activities using a data enabled device 26, such as an iPod Touch, iPad, portable e-Reader, a personal computer, a portable game player, a game console, a laptop, a television set or a netbook computer, all of which can connect to the Internet. Messaging is carried out bi-directionally between the data enabled device 26 (non-telephony device, smartphone or other data devices) and other SMS/MMS capable devices. The messaging hub 100 is implemented without any add-ons, that is, without requiring the user to attach accessory electronic devices, and is implemented via a the messaging hub 100 that maintains an Internet connected server that interfaces with certain wireless messaging facilities in the global messaging infrastructure 20 to establish device-to-wireless communications. In different embodiments, the messaging hub 100 may be a separate dedicated entity, or may be a service entity set up within a mobile service provider to service data enabled devices 26 of some of the provider's subscribers. Further, the messaging hub 100 may provide applications for managing the address books, messages and account information of the user.

When the messaging hub 100 is a separate message service center entity, the messaging hub 100 operations may be incorporated by one or more mobile providers to extend their subscriber service capabilities and the provider entity may provide dedicated connections for affecting coordination between services, call logs and billing for the affected accounts.

Features of the messaging hub 100 may be provided within, or as external hosting services communicating with an existing mobile network provider as a web based application using advanced web capabilities, and may be configured to handle all forms of messaging for the subscribers. In such embodiments, a web client application provides the user with a single integrated interface wherein the subscriber can view or send SMS/MMS/EMS messages, tweets (integrated with Twitter), chat (for which the system supports MSN or AIM or Yahoo or GoogleTalk or Facebook or other similar IM service as the chat client), or status, for example Facebook Status. Subscription/Unsubscription operations can be performed from a web client running on any data enabled device 26 that supports standard Internet browsers or from IP based applications.

Now referring to FIG. 3, another embodiment of a messaging hub 100 operates with other data enabled devices 26 having additional messaging and application features supported by the mobile carrier provider and the phone manufacturer. In one embodiment, a data enabled device client app 48 (also referred to as smart phone app 48) is loaded on the data enabled device 26 through one of several mechanisms including, but not limited to:
downloading from an Apple/Android/etc. App Stores;
downloading from an Enterprise specific Apple/Android/etc. App Store (e.g., available from Apple and Google for a fee); and
pre-loading on an Enterprise personnel's device by the Enterprise IT department.
   Examples of data enabled device 26 supporting the smart phone app 48 include smart phones and tablets running the Android™ operating system and Apple Corporation's iPhones, iPads and iPods. The messaging hub 100 includes a set of Representational State Transfer (REST) web services 156 (also referred to as REST web services 156). The messaging hub 100 further includes hub application 42 which includes a notification queue 162 and a queue listener 164 which is interfaced to an external Push notification server 168. The hub application 43 also includes a user device delivery selector 157.

The data enabled device client app 48 (also referred to as smart phone app 48) communicates with the messaging hub 100 via the REST web services 156. The first time the data enabled device 26 runs the smart phone app 48, the application requests an Auth Token from the REST service. The Auth Token is delivered by the web service via the Push Notification Server 168. This Auth Token is stored by the smart phone app 48 and passed to the Push Notification service with every subsequent call for verification/security purpose.

After getting the Auth Token, the smart phone app 48 requests a telephone number. This number is then used by the smart phone app 48 to send and receive SMS/MMS/EMS messages. The REST web services 156 deliver a unique identifier (e.g., a telephone number) and also create a User login account that can be used for logging onto the web/application. The inbound messages enter the messaging hub 100 through the SMS provider 120, which connects to the inbound service 124. The inbound service 124 pushes out a Message Received notification via the Push Notification Server 168 using the notification queue 162 and the queue listener 164. When the smart phone app 48 gets the Message Received Notification, it retrieves the message from the messaging hub 100 through a connection to the messaging hub 100 REST services 156. All the notifications are delivered to the Notification Queue 162, from where they are picked up by the Queue Listener 164 and delivered to the Push Notification Server 168. The Hub application 42 can initiate a request to upload contacts from the data enabled device 26. This request goes through the notification server 168 and the smart phone app 48 uploads the contacts by calling the REST service 156. Uploaded contacts allow the messaging hub 100 to cross reference the contacts allowing a user to send a message via name and be notified of a received message by name instead of phone number. Additionally locator/tracking features by name are enabled by contact information. Outbound messages are process by the REST web services 156 as part of the Hub application 42. The messages are transferred to the SMS provider 120 for delivery through the global messaging infrastructure 20.

To insure that a text message is delivered to the right device and to prevent anyone spoofing the address when a push notification is not available, the messaging hub 100 architecture utilizes a session based communications model requiring authentication by login with userid and password registered devices or a non-registered device is being used (e.g.—a PC), Thus, it is virtually impossible to have a combination of an unregistered, unauthorized, or unrecognized device receive messages without some form of legitimate userid/password combination to establish the session. The user device delivery selector 157 determines which of possibly several data enabled devices 26 belonging to a user and registered with the messaging hub 100 should receive a particular message according to one or more policies or preferences of the user and the enterprise.

In one specific embodiment supporting the Apple iOS environment (i.e., Apple iOS devices, iPhone, iPod touch, iPad etc.), the Push Notification Server 168 is an Apple Push Notification Server. When used with a smart phone such as an iPhone, a Droid, a Windows Mobile-based phone, or a tablet or other device phone having the system may also be configured to operate with a Pull service.

The PULL service is similar to the PUSH service described above, but instead of messages being pushed they are pulled to the data enabled device 26. Here, in the PULL model, the smart phone app 48 on the data enabled device 26 (e.g.—phone, tablet, etc.) issues a ‘query’ which is routed to a PULL notification server 169 to retrieve any available messages available to the phone number. In other words, the data enabled device 26 poll the PULL notification server 169 on the messaging hub 100 to see if there are any unread messages available for the user.

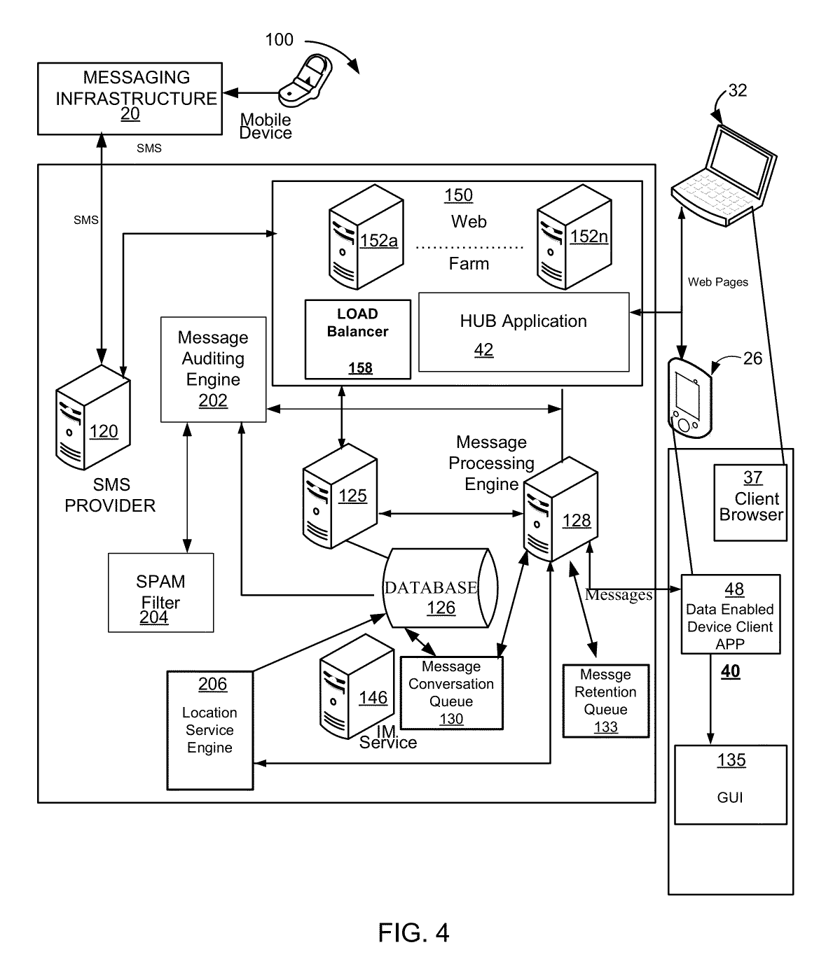

FIG. 4 illustrates the architecture of one embodiment of the messaging hub 100 for multiple messaging applications. The messaging hub 100 includes an SMS provider 120 which provides the interface to the global messaging infrastructure 20 and in particular in one embodiment to the local SMSCMMSC 12, SMS aggregator 14 and (SMS-GW) 18. The SMS provider 120 is used to send and receive SMS/MMS/EMS messages respectively to and from: a mobile phone 29 through the cellular phone infrastructure 28 or a data enable device 26 shown here as laptop personal computer 32 and a data enabled device 26.

The SMS provider 120 is interfaced to a web farm 150 having one or more servers 152a-152n (collectively referred to as web server 152). The servers 152a-152n store the SMS/MMS/EMS messages received and SMS/MMS/EMS messages to be delivered in conjunction with database server 125 and database 126.

The servers 152a-152n also support a Hub application 42 which runs in conjunction an application 40 on data enabled device 26, here laptop 32 or smart phone The web farm 150 is coupled to a database server 125 and corresponding database 126 which is used to store user information including the association between the assigned unique identifiers and data enabled device identifiers. The database 126 also stores and provides contact management data, application management data and message management data.

The messaging hub 100 further includes a common message conversation queue which is interfaced to the database 126 and the message processing engine 128. The database server 125 is connected to a message processing engine 128 which has an associated message processing database (not shown). Database server 125 in conjunction with database 126 primarily stores SMS messages and certain user information and it is used when interfacing to the global messaging infrastructure 20. Database 136 is used in conjunction with other messaging functions such as IM, Chat, etc.

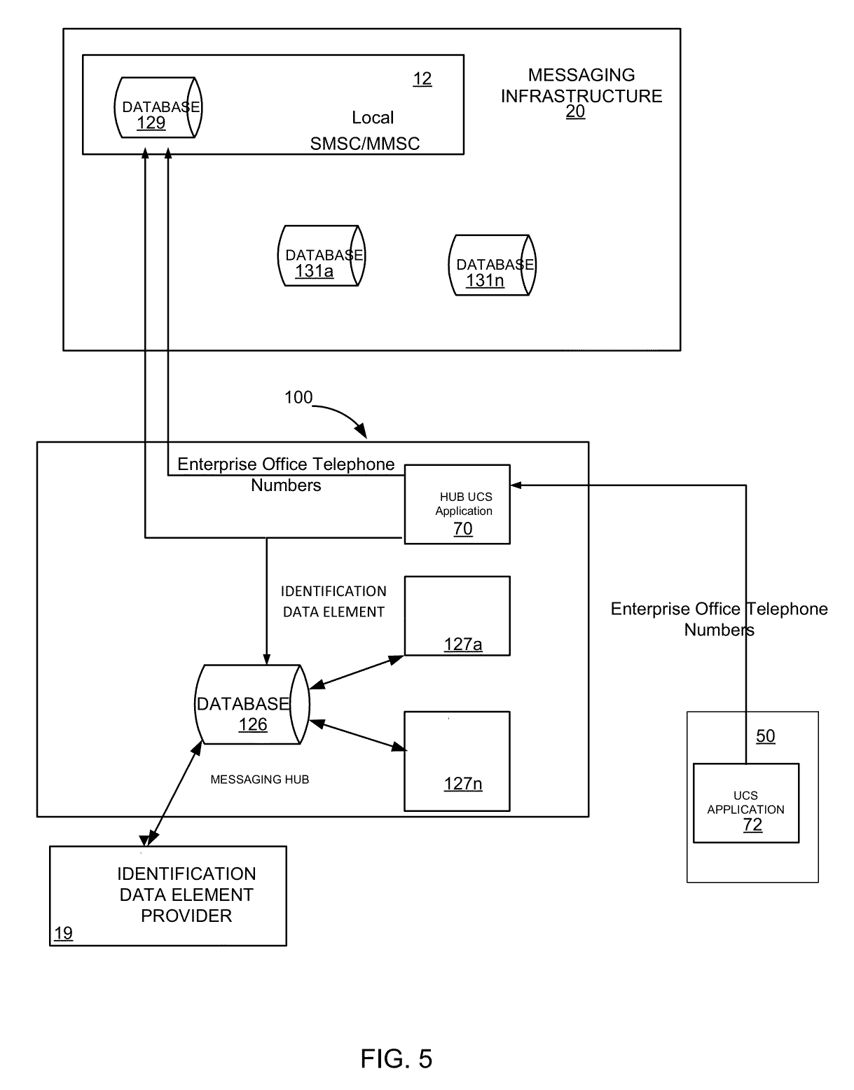

The messaging hub 100 further includes a load balancer 158 connected to the servers 152 in web farm 150 enabling a round-robin mechanism for distribution of the requests and connected to the clients, outside messaging service operators and messaging queues. A location service engine 206 is connected to the database 126 and to a Hub UCS application 70 (FIG. 5). The messaging hub 100 further includes a message auditing engine 202 and associated SPAM filter connected to the database 126 and the message processing engine 128.

The components of the messaging hub 100, in one embodiment, are developed in C, C++, JAVA® or other suitable programming language, and include web servers, such as Apache, Microsoft Internet Information Services platform (IIS) or other suitable server systems operating on a UNIX, Microsoft or other operating system platform to store and communicate messages to Internet devices. An exemplary software framework for the messaging hub 100 includes the following:

The Hub application 42 on servers 152a-152n runs, for example, on a .Net framework and is hosted on a Microsoft IIS7 system on a windows 2008 server.

The database 126 is a relational database implemented in this embodiment using a 2008 SQL Server, and the message processing engine 128 is implemented as a COMET server, using Frozen Mountain's COMET engine (using .net framework on IIS7).

The SMS provider 120 is a C++ server application which interacts with the messaging infrastructure 20.

In operation, the SMS provider 120 determines from the destination of a received message where to route the message through the global messaging infrastructure 20. The message may be routed through to one of the SMSC 12, the SMS aggregator 14 the (SMS-GW) 18 or other communications entity, operated by a mobile operator, aggregator or some other intermediary.

The messaging hub 100 consolidates message delivery into a common message conversation queue 130 and intermixes messages from other messaging services, including presence activity and geographic location data into the common message conversation queue 130. This consolidation, allows the messaging hub 100 to enable personal replies to be threaded back to the user's inbox so individual chat conversations can continue across multiple data enabled devices to provide multi-screen messaging.

A user can read a message from anywhere and respond on any device with the same phone number. Chat based systems, such as Facebook, are operated using the common message conversation queue 130 to facilitate combined common message conversations.

When used to support multiple mobile network providers, advantageously, the messaging hub 100 is configurable for each provider. An instance of the messaging hub 100 is set up for each Enterprise and includes separate instances of the database 126. It is understood that the various server functions of the messaging hub 100 could be run on a single computer or multiple computers, storage could be provided by individual storage media or a storage area network.

In operation, the Load Balancer 158 performs the function of ensuring distribution of incoming and outgoing messages are spread uniformly across the deployed number of servers to prevent I/O bottlenecks and delays that can occur if all or majority of requests are grouped at a single finite server. The Location Service is a processing engine which receives assorted geographic information from client devices, some in exact form such as latitude and longitude data derived from the client device which could be from GPS if so equipped. Additional forms of geo-location data may be derived from cellular radio tower triangulation data from the device client data if the device is so equipped. Another form could be the IP address assigned to the device, which the Location Service, in conjunction with IP address geo-location data as obtained or provided, can calculate the approximate geo-location of the device. The geo-location data can be provided as a service to relevant interested entities of the location of the device at any given time period or point such as the client user or an Enterprise of which may be the master account holder of the device and/or services.

Message auditing provides the function of logging of message traffic encompassing time, date, duration, origin, destination and network related data. The purpose of such data can be used for accounting purposes (financial, technical), law enforcement compliance requests, data statistical analysis and archival retention for future reference. All or set filtered messages that flow through the UCS 50 can be set to record desired auditing data.

The SPAM filter function provides removal and/or quarantine function of SMSMMS/EMS messages that are determined by a pre-defined set of criteria to be unwanted or of risk to the health of the UCS 50 and its clients. The pre-defined set of criteria for filtering can be set by the owner of the UCS 50 or the Enterprise or the individual user or any combination of. The quarantine function enables the isolation of SMS/MMS/EMS messages for further review at a future time period. Additional criteria of the UCS SPAM filter may encompass the use of frequency of sending or receiving SMS/MMS/EMS messages within a specific time period. If the criteria are set where a human cannot possibly send a predetermined number of messages per minute (or any other interval) is exceeded from a specific client, then the filter has the ability to convey immediate shutdown of that client or removal of messages being generated from that client from the UCS. All messages or defined subset of messages are passed through the SPAM filter.

Location services are provided by the messaging hub 100 in conjunction with location service engine 206. Location services include, for example, determining a location of one of the user devices, communicating the location of one of the data enabled device 26 to the unified communications service and delivering a location specific message to the located data enabled device 26. Location can be determined through use of GPS service information if the data enabled device 26 has a GPS chip. Additionally, cell tower triangulation information is also available if the data enabled device 26 is equipped with cellular network access and is active. Another location determination alternative is IP address allocation by the data enabled device 26. IP address blocks are assigned by geographic areas in the world, and depending on the internet service provider (ISP), information can be provided to locate the data enabled device 26 within a reasonable physical geo-location of the data enabled device 26.

FIG. 5 illustrates further details of the provisioning process. The messaging hub 100 includes a Hub unified communications service (UCS) application 70 which communicates with a corresponding UCS application 72 in the unified communications service 50 over the secure connection 60. An enterprise office telephone number (or a block of numbers) is transferred to the messaging hub 100. The enterprise office telephone numbers are pushed or published into the database of the various directories, for example a database 129 of the local SMSC/MMSC 12 or databases 131a-131n of other SMSC/MMSCs in the global messaging infrastructure 20. The messaging hub also registers enterprise office telephone numbers in a database 126. In one embodiment, the enterprise office telephone numbers are registered in a plurality of virtual databases 127a-127n (supported by physical database 126), each virtual database corresponding to a different enterprise.

Landline numbers are not typically registered with any of the operators or SMS/MMS aggregators within the mobile ecosystem. When SMS/MMS messages are processed by a mobile operator or SMS/MMS aggregator, the aggregator or operator needs to find a registered number in the various directories to determine if the number is a legitimate and active number and where to route the SMS/MMS message. All phone numbers are associated with an “owner of record” in the various databases in the mobile ecosystem and the appropriate routing destination is determined by “who” the owner of record is for the particular number in question.

The Messaging hub system 100 enables recognition and routing capabilities by provisioning landline numbers into the various databases in the mobile ecosystem. When an entity such as any mobile operator or SMS/MMS aggregator receives a message for routing, upon query to one or more of the industry's databases, it determines who is the owner of record for the message based on the destination phone number of the SMS/MMS message.

For example in one embodiment, a message with a destination phone number of +1 212 555-1234, that was provisioned by Messaging hub 100 into the various databases, is identified as Messaging hub 100 as the ‘owner of record’, and thus routed to Messaging hub servers and network for handling. Upon receipt by Messaging hub 100, the SMS provider 120 in conjunction with the web servers 152 which maintain state and session information and using records in the database 126 can determine the actual user of the phone number and locate the active devices by the user wherever the devices is using the Internet, then deliver the message to the device, or queue the message if no session is possible with any of the user devices associated with the user at the time the message arrives. The directories including these databases are situated in a local or regional network. There are copies of a government master directories and subsets of the master government directories which are used and provided by the government.

Provisioning of the enterprise office telephone numbers (obtained from the UCS 50 through UCS application 72 and Hub UCS application 70 in the messaging hub 100) into all the assorted databases, public and private, in the global messaging infrastructure 20 requires recognition and allowance by the mobile operators for mobile messages from non-mobile operator sources to flow through the network. This recognition and allowance is provided in advance of provisioning of enterprise office telephone numbers. As a result of provisioning by the message hub 100, the enterprise office telephone numbers reside and are registered in databases that are queried by the SMSC/MMSCs.

Every SMS/MMS message originating or terminating from a predefined set of enterprise office telephone numbers is also associated with a specific or group of specific an identification data element, for example a Service Profile Identifier (SPID) electronic SPID (eSPID) virtual SPID (vSPID) alternate SPID (AltSPID) identifier of a second service provider (collectively referred to as SPID) or a Session Initiation Protocol (SIP) uniform resource identifier (URI) (SIP URI), in a database for identification purposes of the originating/terminating enterprise. A SIP URI is very similar to an Internet URL and is generally a way to assign an IP address (by pseudo name) to resources as the ‘owner’ (i.e., accomplishes the same task as a SPID, but using Internet IP technology).

A Letter of Authorization (LOA) is required in order to provision phone numbers into the various industry databases from the “owner of record” of the phone numbers. LOA's are business legal agreements/contracts between two parties that authorize from the owner of record for specified phone numbers to allow the designee permission to use the specified phone numbers for the specific purpose listed in the LOA. LOA's can be generated for a single phone number. However, the normal LOA will cover a range of phone numbers, such as 617-555-0000 through 617-555-9999, or whatever range is designated. If the target phone numbers are not sequentially numbered, then each number would be targeted number would be listed in the LOA.

For example, if X Corp is the “owner of record” of a phone number, but someone else, for example the Messaging hub 100 will route messages on behalf of an some X Corp employee (user of the phone number), an LOA is required by all of the database owner operators to allow “provisioning” into the database of an alternate ‘route’ for the intended phone number. In other words, the LOA grants “permission” to Messaging hub 100, to utilize the phone number for an alternative purpose as specified in the LOA. Here, Messaging hub 100 uses the LOA to enable SMS/MMS alternative routing. The LOA is the permission to use the phone numbers for the specific purpose, here for SMS/EMS traffic.

A Service Profile Identifier (SPID) is a number that identifies a specific carrier network or subset network of a larger carrier network. A Session Initiation Protocol Uniform Resource Identifier (SIP URI) is a data set that identifies a specific carrier network, subset network of a larger carrier network, network service provider, virtual network service provider or service provider. When an enterprise obtains telephony service 51, a telephone company assigns a SPID to the line. The first 10 digits identify the telephone number, called the Directory Number (DN). All SMS messages are associated with a particular an identification data element (e.g., SPID or SIP URI) for identification/ownership/association purposes, and the SPIDs or SIP URIs are processed by

Messaging hub 100. The an identification data element (e.g., SPID or SIP URI) indicates that, for example, an SMS message is coming from or being sent to Enterprise XYZ Corporation. Handling the identification data element is part of the provisioning process. When messaging hub 100 provisions a phone number or block/range of numbers, an identification data element is associated with each number to identify the associated Enterprise user of those numbers.

In one embodiment, E.164 numbers are used. E.164 is an ITU-T recommendation that defines the international public telecommunication numbering plan used in the PSTN and some other data networks. It also defines the format of telephone numbers. E.164 numbers can have a maximum of fifteen digits and are usually prefixed with a ‘+’. To actually dial such numbers from a normal fixed line phone, the appropriate international call prefix must be used.

The identification data elements (e.g., SPID, ESPID, VSPID and AltSPID) are generated by different organizations. The OCN/SPIDs are generated by NECA (National Exchange Carrier Association) in North America. In the rest of the world, it is handled by its counterpart organizations. ESPID, VSPID and AltSPID are generated by a variety of organizations including NetNumber, TNS, SAP, Syniverse, MACH, Neustar and BICS. ESPID, VSPID and AltSPID are ‘private/proprietary’ versions of the SPID. They are used by the private databases operated by NetNumber and others to ‘route’ traffic associated with that particular ESPID/VSPID/AltSPID. The ESPIDs, VSPIDs and AltSPIDs can be used to denote ‘sub-category’ traffic of a larger SPID (e.g., AT&T) to create sub-categories under AT&T.

The identification data elements (e.g., SIP URIs) are generated by the owning organizations of the service provider of the services being provided to the Enterprise for the non-mobile messaging services. Its purpose is to provide a uniform standard network identification format based upon industry standards utilizing conventional and accepted Internet addressing mechanisms that enable the location of the owning service provider network to be discoverable for routing purposes. It is understood that a SIP URI refers to refers to an Internet IP location/address while an SPID is a label, however both serve a similar identification purpose.

In one embodiment, the provisioning process includes:

provisioning the specific office number or block of office landline phone numbers into mobile ecosystem including assigning unique SPID or other network identifier of its unique SMS/MMS traffic for the specific enterprise business; and

provisioning specified block of numbers to databases of all mobile entities involved in SMS/MMS traffic routing (e.g., Verizon, AT&T, Sybase, Syniverse, etc.). After provisioning, the SMS/MMS routers and handlers in the mobile network recognize the DID's associated with provisioned Enterprise business as belonging to a particular identification data element (e.g., SPID or other network identifier) and as such, will route appropriately based on assigned SPID or SIP URI to the messaging hub 100. Whenever any SMS/MMS router or handler within the mobile network encounters a message associated with the corresponding assigned identification data element, the router will either direct the inbound messages toward the messaging hub 100 designated for handling that identification data element or be routed to the appropriate routers or servers for processing for outbound messages.

As part of provisioning, the identification data element assigned to Enterprise business is ‘homed’ within the messaging hub servers 152 and message processing components for specific Enterprise business traffic (for delivery in both directions based on the identification data element). Provisioned Enterprise business DID traffic is handled as follows:

Outbound messages (MO)—the user of the Enterprise business landline DID sending the SMS/MMS message has the landline DID associated as the origin DID of the SMS/MMS message; and

Inbound messages (MT)—the destination Enterprise business SMS/MMS message traffic will be processed by redirection at the messaging hub 100 to the IP session assigned for that destination landline DID; if no session exists at the time of message delivery, the message will be queued for later delivery when an IP session for the landline DID is established;

IP sessions between messaging hub servers 152 and users of Enterprise business landline DID's are setup automatically between the software clients (i.e., data enabled device client app 48) on mobile devices and/or fixed landline terminals (e.g., desk phones with text display capabilities) upon initiation by the user or other automated mechanisms, under control of the Enterprise, user or other administrative entities. Some desk phones, if the phone has a text display and appropriate intelligence in the form of processing capabilities (CPU, memory, etc.) similar to a mobile phone handset or tablet or PC with the appropriate software for the desk phone, could display and send SMS messages as well.

The messaging hub 100 and provisioning process enables a person associated with an enterprise to use his or her enterprise office telephone number (landline number) for a new purpose: mobile messaging. Mobile messaging using the landline number can be accomplished on any mobile IP device in the world where there is IP connectivity, to send and receive mobile messages, using his or her office landline number. This allows a person to have “one telephone number” for their business communications including voice and mobile messaging, in contrast to having two separate telephone numbers (one for office and one for mobile).

In FIG. 6, flowchart 600 diagrams the overall process of enabling an enterprise office telephone number to be used for SMS/MMS/EMS message communication. In step 610 the messaging hub 100 establishes a secure connection between the messaging hub local SMSC and a data adapter of a unified communications service and identifies the enterprise office telephone number in step 620. In step 630, the enterprise office telephone number is provisioned by registering the enterprise office telephone number with a messaging hub having access to a local SMSC/MMSC in step 632, gaining access to the mobile message network using the enterprise office telephone number in step 634 and registering the enterprise office telephone number in a database accessible by an SMSC/MMSC with access to the global SMS/MMS network (e.g., messaging infrastructure 20) in step 636. In certain embodiments provisioning occurs into a third party directory, a carrier's directory, a government directory or a government master directory. An example of a third party directory includes the Tata Telecom Directory services (Indian conglomerate that provides global directories for carriers). Examples of government master directories include Neustar (the Number Portability database) and Ericsson (the LERG, which is all North American phone numbers and their routes). Copies of a government mater directories and subsets of the master government directories are used and/or provided by various governments. It is understood, that in some jurisdictions (e.g., North America), it is possible to provision into common databases while in other jurisdictions a similar effect is obtained by provisioning into separate operator databases thereby having a combined effect of provisioning into a common database.

In step 640, an identification data element to be used in conjunction with the enterprise office telephone number assigning is assigned, and in step 650, the assigned identification data element within the messaging hub 100 is homed for message traffic delivery. As part of provisioning, the identification data element assigned to enterprise office telephone number is ‘homed’ within messaging hub 100 servers for specific enterprise business traffic (for delivery in both directions based on the identification data element). Every SMS message originating or terminating from a predefined set of enterprise office telephone numbers will be associated with a specific or group of specific identification data elements, in a table for identification purposes of the originating/terminating enterprise.

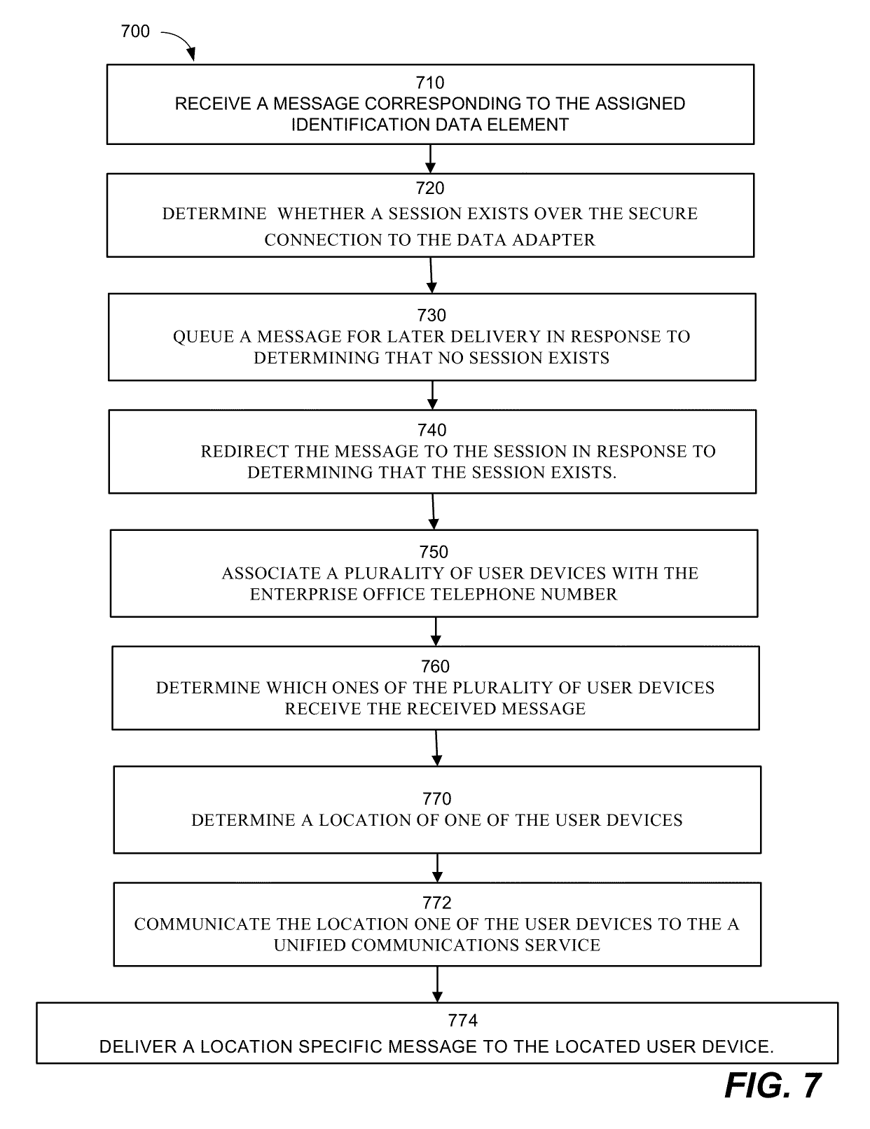

FIG. 7 diagrams further steps in the process of enabling an enterprise office telephone number to be used for SMS/MMS/EMS message communication by the messaging hub 100. In step 710 a message corresponding to the assigned identification data element is received. In step 720, it is determined whether a session exists over the secure connection to the data adapter, and in step 730, a message is queued for later delivery in response to determining that no session exists. In step 740, the message is redirected to the session in response to determining that the session exists. A session is determined to exist based on presence state information maintained by the messaging hub 100 of all registered user data enabled devices 26. In one embodiment, MRU (Most Recently Used) state information is maintained in order to predict the highest probability of the device amongst a plurality of data enabled devices 26 owned/used by the user, being the active device being used at the moment.

Delivery of messages is facilitated by the use of a push service provided by the messaging hub 100 to transfer a message from the messaging hub 100 to the unified communications service 50 via the messaging application. In other embodiments, delivery of messages is facilitated by the use of a pull service to transfer a message from the messaging hub 100 to the unified communications service via the messaging application.

In step 750, a plurality of user devices is associated with the enterprise office telephone number, and it is determined which ones of the plurality of user devices receive the received message at step 760.

At step 770, a location of one of the user devices is determined. The location of the user device is determined by its registered IP address at that moment on the global Internet, provided as part of the session information data when the device connected to the messaging hub 100, which provides the network routing information for the message through standard TCP/IP networking protocols. At step 772, the location one of the user devices is communicated to the unified communications service and a location specific message is delivered to the located user device at step 774.

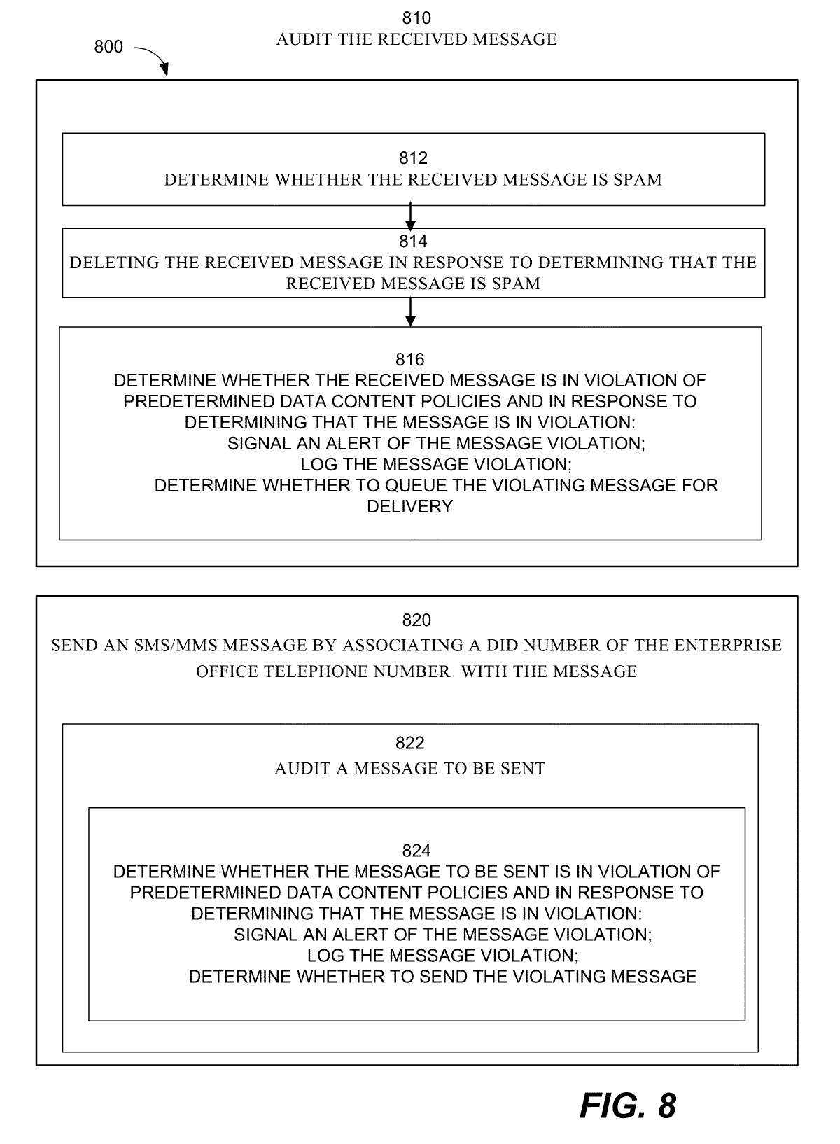

FIG. 8 illustrates additional steps performed by the messaging hub 100. In step 810, the received message is audited. In one embodiment, it is determined whether the received message is spam at step 812 followed by step 814 where the received message is deleted in response to determining that the received message is spam. In step 816, it is determined whether the received message is in violation of predetermined data content policies and in response to determining that the message is in violation, an alert of the message violation is signaled, the message violation is logged, and it is determined whether to queue the violating message for delivery. The alert can be signaled, for example, by sending a text message or an email to an administrative entity of the business enterprise.

At step 820, an SMS/MMS message is sent by associating the direct inward dial (DID) number or the enterprise office telephone number with the message and at step 822, the message to be sent is audited. At step 824, it is determined whether the message to be sent is in violation of predetermined data content policies and in response to determining that the message is in violation, an alert of the message violation is signaled, the message violation is logged and it is determined whether to allow the violating message to be sent. It is understood, that if a message cannot be sent under certain circumstances including communication problems with the local SMSC or other carriers, the message can be queued for later delivery.

An enterprise in communication with the messaging hub 100 can monitor, audit and track SMS communications by its personnel with the implementation of messaging hub 100 Enterprise services for SMS/MMS communications. The SMS/MMS client software on the Enterprise personnel's mobile devices and PC's in combination with the messaging hub 100 server side monitoring and auditing functions can be set through parameters to search and trigger based on whatever keywords (e.g.—merger, acquisition, stock price, etc.) and/or phrase (e.g.—“. . . we're going to miss our quarterly numbers . . . ”) and/or patterns (e.g.—messages being sent/received to certain area codes, numbers; high activity during certain periods of time of month/quarter, etc.).

In addition, the ability to monitor and search SMS/MMS communications from outside an Enterprise is provided by the messaging hub 100 when the Enterprise personnel communicate with third parties on the global PSTN via SMS/MMS. For example, an enterprise personnel John using having a data enabled devices 26 and an enterprise office telephone number, receives SMS message direct to his enterprise office telephone number from his buddy, Tom. Tom is not using a phone number associated with and enterprise UCS connected to the messaging hub but is using, for example, a standard SMS service from a carrier (e.g., AT&T). In such a scenario, even though Tom is using standard SS7 based SMS service, the message and its contents are completely available to the Enterprise for auditing (e.g., Message Auditing engine 202) and filtering (e.g., Spam Filter 204) purposes because it is routed through Messaging hub servers to reach ‘John’. Embodiments disclosed herein, provide the capability for Enterprises to monitor and audit its employees' SMS/MMS communications to protect its intellectual property and financial data.

While configurations of the system and method have been particularly shown and described with references to configurations thereof, it will be understood by those skilled in the art that various changes in form and details may be made therein without departing from the scope of the invention. As an example, the order of processing steps in the flow charts is not limited to the order shown herein. Accordingly, the present invention is not limited by the example configurations provided above.

What is claimed is:

1. A computer-implemented method for enabling an enterprise office telephone number to be used for SMS/MMS/EMS message communication, the method comprising:
establishing a secure connection between the messaging hub local SMSC and a data adapter of a unified communications service;
identifying the enterprise office telephone number;
provisioning the enterprise office telephone number, the provisioning comprising:
registering the enterprise office telephone number with a messaging hub having access to a local SMSC/MMSC;
gaining access to a mobile message network using the enterprise office telephone number; and
registering the enterprise office telephone number in a database accessible by an SMSC/MMSC with access to a global SMS/MMS network.

2. The computer-implemented method of claim 1, further comprising:
assigning an identification data element to be used in conjunction with the enterprise office telephone number;
homing the assigned identification data element within the messaging hub for message traffic delivery and
wherein the identification data element is one of:
an SPID;
an ESPID;
an VSPID;
an AltSPID; and
a SIP URI.

3. The computer-implemented method of claim 2, further comprising:
receiving a message corresponding to the assigned identification data element;
determining whether a session exists over the secure connection to the data adapter;
queuing a message for later delivery in response to determining that no session exists; and
redirecting the message to the session in response to determining that the session exists.

4. The computer-implemented method of claim 3, further comprising auditing the received message.

5. The computer-implemented method of claim 4, wherein auditing comprises:
determining whether the received message is in violation of predetermined data content policies and in response to determining that the message is in violation:
signal an alert of the message violation;
log the message violation;
determine whether to queue the violating message for delivery;
determining whether the received message is spam; and
deleting the received message in response to determining that the received message is spam.

6. The computer-implemented method of claim 3, further comprising:
associating a plurality of user devices with the enterprise office telephone number; and
determining which ones of the plurality of user devices receive the received message.

7. The computer-implemented method of claim 6, further comprising
determining a location of one of the user devices;
communicating the location of one of the plurality of user devices to the unified communications service; and
delivering a location specific message to the one of the plurality of user devices.

8. The computer-implemented method of claim 1, further comprising:
sending an SMS/MMS message by associating a DID number of the enterprise office telephone number with the message.

9. The computer-implemented method of claim 8, further comprising auditing the a message to be sent.

10. The computer-implemented method of claim 9, wherein auditing comprises:
determining whether the message to be sent is in violation of predetermined data content policies and in response to determining that the message is in violation:
signal an alert of the message violation;
log the message violation; and
determine whether to send the violating message.

11. The computer-implemented method of claim 1, wherein identifying the enterprise office telephone number further comprises identifying a block of enterprise office telephone numbers.

12. The computer-implemented method of claim 1 further comprising providing a messaging application running on the messaging hub and within the unified communications service.

13. The computer-implemented method of claim 1 further comprising providing a push service to transfer a message from the messaging hub to the unified communications service via the messaging application.

14. The computer-implemented method of claim 1 further comprising providing a pull service to transfer a message from the messaging hub to the unified communications service via the messaging application.

15. The computer-implemented method of claim 1 further comprising provisioning into at least one of:
a third party directory;
a carrier's directory;
a government directory; and
a government master directory.

16. A messaging hub for enterprise Short Message Service/Multimedia Messaging Service/Enhanced Messaging Service (SMS/MMS/EMS) communications comprising:
an interface to a local SMSC/MMSC;
at least one application server coupled to the local SMSC/MMSC through the interface;
wherein the local SMSC/MMSC is an interfaced to at least one external SMSC/MMSC in an external SMS/MMS/EMS network;
a database coupled to at least one database server coupled to the application server providing contact management data, application management data and message management data;
an interface between the messaging hub and a data adapter of a unified communications service;
an application interface to a unified communications service;
a message retention queue for delaying delivery of SMS/MMS/EMS messages; and
an interface to a push service.

17. The messaging hub of claim 16 further comprising an interface to a pull service.

18. The messaging hub of claim 16 further comprising an auditing engine including a spam filter.

19. The messaging hub of claim 16 further comprising a user device delivery selector.

20. The messaging hub of claim 16 further comprising a location services engine.

21. A computer readable storage medium for tangibly storing thereon computer readable instructions for a messaging application having an on premise component and a messaging hub component, the messaging hub component having for a method comprising:
establishing a secure connection between the messaging hub local SMSC/MMSC and a data adapter of a unified communications service;
identifying the enterprise office telephone number;
provisioning the enterprise office telephone number, the provisioning comprising:
registering the enterprise office telephone number with a messaging hub having access to a local SMSC/MMSC;
gaining access to the mobile message network using the non-mobile enterprise office telephone number; and
registering the enterprise office telephone number in a database accessible by an SMSC/MMSC with access to the global SMS/MMS network;
the on premise component comprising instructions for a method comprising
transferring an enterprise office telephone number over the secure connection; and
sending and receiving SMS/MMS messages over the secure connection.
